(19) United States
(12) Patent Application Publication
(10) Pub. No.: US 2004/0030900 A1
(43) Pub. Date: Feb. 12, 2004

(54) Undetectable watermarking technique for audio media

(76) Inventor: James R. Clark, Aurora, CO (US)

Correspondence Address: Ken J Pedersen, Pedersen & Company, PO Box 2666, Boise, ID, 83701-2666, US

(21) Appl. No.: 10/332,878

(22) PCT Filed: Jul. 13, 2001
(86) PCT No.: PCT/US01/22094

(51) Int. Cl. H04L 9/00

(52) U.S. Cl. 713/176

(57) ABSTRACT

Embodiments of the present invention relate to the embedding of signature or watermark identification into digitally encoded audio data. More specifically, the present invention relates to embedding a unique digital identifier into the sub or super-audio frequency of digital audio data. As such, the present invention allows for an inaudible watermark to be embedded into any digital audio data.

### BACKGROUND OF THE INVENTION

Field of the Invention

Embodiments of the present invention relate to the embedding of signature or watermark identification into digitally encoded audio data. More specifically, the present invention relates to embedding a unique digital identifier into the sub or super-audio frequency of digital audio data. As such, the present invention allows for an inaudible watermark to be embedded into any digital audio data.

### SUMMARY OF THE INVENTION

As an introduction to the problems solved by the present invention, consider that the expansion of usage of the Internet has created a demand for high levels of security over what is basically an open digital communications network. To provide security and privacy of digital audio content information, a large variety of creative encryption and security procedures currently exist.

The present invention, as described herein, can protect any type of digitally encoded audio content, of both encrypted and non-encrypted forms. The system uses a novel and innovative process of adding a secure identification signature or watermark directly into the audio data content of any digital data file. For instance, the watermark may be embedded within a digital audio or video data file.

In one embodiment of the invention, a method of encoding an identifying signature or A watermark into audio information is accomplished by mixing an inaudible, data-modulated analog signal onto an existing audio signal, such as a piece of music. The embedded signal is based on a frequency that is above or below the range of human hearing, thus being inaudible. This inaudible information can be digitally encoded onto a standard format audio compact disc (CD), and can be subsequently detected through use of a demodulating or decoding circuit on a standard computer peripheral reading device (e.g. CD-ROM). To a discerning human listener, the signature or watermark will be undetectable when played on any standard playing device.

Another embodiment makes use of a microprocessor or digital signal processor to create digitally mixed audio data, in digital form such as in audio CD format, with a result that is formed algorithmically from the combination of existing, unsecured digital audio data and the newly encoded watermark data that represents those same inaudible signals as described above. The resultant data file set exists in standard audio CD format, but contains watermark security. This digital image can subsequently be written to a standard audio CD.

Another embodiment of the present invention makes use of a unique hardware identifier to create the embedded signature or watermark. For example, a unique serial number may be used to form the signature or watermark which is embedded into the digital audio data file. This could be a MAC code on a network card, a serial number in an EPROM, or a unique identification number on a CPU or other IC of any type. For example, the unique identification embedded in each Pentium III® chip could serve as a PC specific identifier used to create the embedded signature or watermark. As a result, any digital copies of the watermarked data can be automatically traced to the original source through the unique hardware identifier.

It is an object of the present invention to overcome deficiencies in current technology which make it impossible to adequately protect copyrighted or otherwise proprietary data made available over the Internet. A further object of the present invention is to provide a system which allows copies of proprietary data to be easily and uniquely traced to the original source through the use of the embedded identifying signature or watermark. For example, Internet devices such as personal computers may access copyrighted content libraries. Any data provided to an Internet device, such as a PC or an MP3 type player, which may digitally reproduce said data, shall be provided in a format which includes the unique identifying signature or electronic watermark. As a result, any digital reproduction of said data may be readily identified and attributed to the uniquely identified Internet device which originally accessed said data. Therefore, the novel system facilitates secure access to copyrighted data from any Internet device via any means of access (modem, ethernet, RF, cellular, etc.).

These and other embodiments, aspects, advantages and features of the present invention will be set forth in part in the description, and in part will come to those skilled in the art by reference to the following description of the invention and referenced drawings, or by practice of the invention. As put forth in the detailed description that follows, this invention will provide an effective and novel means of creating and detecting watermarked audio content.

### BRIEF DESCRIPTION OF THE DRAWINGS

FIG. 1 is a illustrates a waveform of one embodiment of a modulation method.

FIG. 2 is a schematic representation of a system capable of both creating and detecting watermark data.

### DETAILED DESCRIPTION OF THE INVENTION

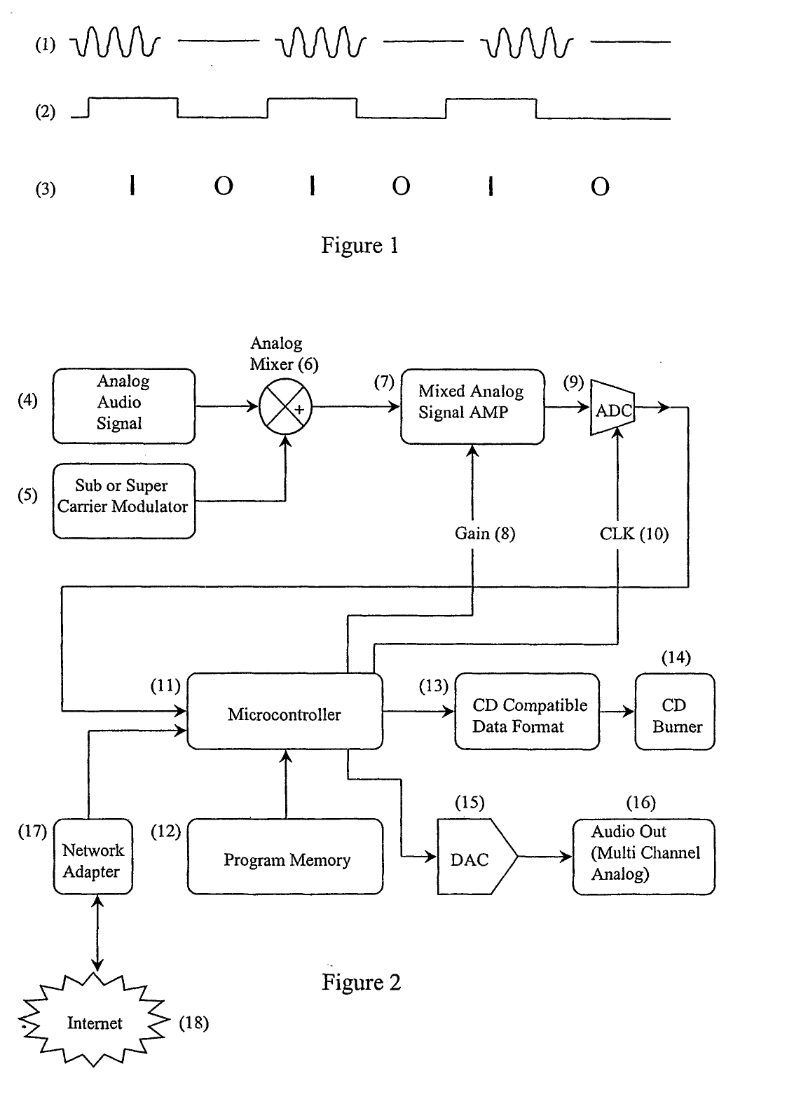

Referring to FIG. 1, which is a waveform of one embodiment of a modulation method, waveshape (1) depicts an on-off tone burst. The frequency of the tone is of a sub or super-audio frequency, for example, at or below 15 IL or at or above 21 KHz. Waveform (2) is a digital signal that represents the periods of tone burst or no-burst as high and low voltages, respectively. The numbers shown (3) refer to the binary value of the modulation of information that is conveyed in the waveforms (1 and 2). Suffice it to say that modulation of a tone can be accomplished by using electronic devices to effectively encode digital information, such as a signature or watermark, into a sub- or super-audio frequency waveform. This waveform can be mixed with another audio signal in a standard way, through a summing amplifier or other mixing means.

Keeping in mind this tone burst modulation technique, another embodiment of this invention involves the use of a digital signal synthesizer circuit. This circuit can directly synthesize a burst modulation waveform using a succession of digital words that define each point of the waveform. The information that describes the waveform is first constructed using digital data words, which can be subsequently converted to an analog voltage using a Digital to Analog Converter (DAC).

Referring to FIG. 2, there is depicted a schematic representation of a system capable of both creating and detecting watermark data. A typical high-fidelity audio signal (4) is fed into a mixer (6) along with a signal that is generated by a sub- or super-carrier modulator (5). The sub and super-audio frequency channels of the original high fidelity signal is cleared by stripping any existing data at said frequencies. For example, inaudible notes in a music file, such as a high flute or low bass note, are stripped from the original high fidelity signal to clear the channel for the encoded signature or watermark. The resultant signal from the mixer circuit (6) is fed into a signal amplifier (7) that is capable of changing gain (8) based upon a separate input. The amplified signal can then be converted into a digital signal through the use of an Analog to Digital Converter device (ADC) (9). The digital data stream is synchronously fed into microcontroller (11) through the use of synchronization clock signal (10). The program memory (12) that directs the processing activities of microcontroller (11) can be written in such a way as to provide a means of processing the synchronous data coming from ADC (9) and assembling the watermarked data and outputting it in a standard audio CD data format (13). This formatted data can then be written onto an audio CD through the use of a CD burner device (14). The microcontroller is also able to output watermarked audio content data through use of a DAC (15) as analog audio data (16).

When equipped with a network adapter (17), the microcontroller gains flexibility in, encoding and decoding streams of audio content data as it is transmitted across a local or wide area network, or upon the Internet (18). It is possible to receive watermarked data for decoding or non-watermarked data for purposes of encoding. It is also possible to send watermarked data onto the network, and to specific or broadcast destinations. Any of these means described above can apply to audio data that contains multiple channels, such as left and right, front and back.

The advantages of this invention for the secure and inaudible watermarking of audio data will be beneficial in the transaction of published audio content, such as music and video. Although this invention has been described above with reference to particular means, materials and embodiments, it is to be understood that the invention is not limited to these disclosed particulars, but extends to all equivalents within the field of this invention.

Although this invention has been described above with reference to particular means, materials and embodiments, it is to be understood that the invention is not limited to these disclosed particulars, but extends instead to all equivalents within the scope of the following claims.

I claim:

1. A method for providing digital information to an Internet device, wherein
a unique identifying signature of the Internet device is incorporated with the provided digital information so that any digital reproduction of the provided digital information may be readily identified and attributed to the uniquely identified Internet device.

2. The method of claim 1 wherein
the Internet device is a PC.

3. The method of claim 1 wherein
the Internet device is a MP3 type player.

4. The method of claim 1 wherein
the identifying signature of the Internet device is incorporated with the digital information by mixing an inaudible, data-modulated analog signal onto an existing audio signal of the digital information.

5. The method of claim 4 wherein
the data-modulated analog signal comprises a tone burst modulation waveform.

6. The method of claim 2, further comprising the PC copying said provided digital information, into which has been incorporated the unique identifying signature, on a compact disc, so that said unique identifying signature is also copied onto the compact disc, and wherein a listener does not hear said unique identifying signature when playing the copied digital information.

7. The method of claim 6, wherein said provided digital information is music.

8. The method of claim 3 further comprising the MP3 type player making a digital copy of said provided digital information, into which has been incorporated the unique identifying signature, so that said unique identifying signature is also copied, wherein a listener does not hear said unique identifying signature when playing the copied digital information.

9. The method of claim 8, wherein said provided digital information is music.
